(19) United States
(12) Patent Application Publication
(10) Pub. No.: US 2010/0301117 A1
(43) Pub. Date: Dec. 2, 2010

(54) System and Method for Storing and Reading Information

(76) Inventors: Arved Hübber, Chemnitz (DE); Thoralt Franz, Oelsnitz (DE); Michael Otto, Chemnitz (DE)

Correspondence Address: RENNER KENNER GREIVE BOBAK TAYLOR & WEBER, FIRST NATIONAL TOWER, SUITE 400, 106 SOUTH MAIN STREET, AKRON, OH, 44308-1412, US

(21) Appl. No.: 12/223,092

(22) PCT Filed: Oct. 10, 2007
(86) PCT No.: PCT/EP2007/060787

§ 371 Date: Jul. 22, 2008

(30) Foreign Application Priority Data
Oct. 12, 2006 (DE) 10 2006 048 401.0

(51) Int. Cl. G06K 7/08; G06K 19/067; G06K 5/00

(52) U.S. Cl. 235/437; 235/451; 235/438; 977/773; 977/943

(57) ABSTRACT

The invention relates to a system and a process for storing and reading information, having a data storage medium for storing information and a reading unit for reading the information stored in the data storage medium, the data storage medium having a dielectric and the information being formed by the presence or non-presence of at least one storage electrode in the data storage medium, and the reading unit having at least one input electrode and at least one reading electrode, it being possible for the data storage medium and the reading unit to be coupled to each other, for the purpose of reading the information, in such a manner that the input electrode and the storage electrode form a first capacitor and the reading electrode and the storage electrode form a second capacitor. The reading unit also has means for generating a digital voltage jump at the input electrode and means for comparing the voltage jump occurring at the reading electrode with a reference voltage.

The invention relates to a system and a process for storing and reading information, having a data storage medium for storing information and a reading unit for reading the information stored in the data storage medium.

Analogue processes which are able to recognise capacitively or inductively the presence or absence of electrically conductive material are known from practice. Analogue signal characteristics, for example sinusoidal oscillation, are input into the material by means of an electrode and taken up by a second electrode. The measured signal can then be analysed in respect of amplitude and optionally phase angle in order thereby to ascertain the presence or absence, and also the conductivity, of the conductive material. This type of measurement permits differentiated evaluation possibilities, for example it being possible to measure capacitances, resistances and inductances.

However, that process has the disadvantage that it is relatively expensive with respect to the required hardware which generates the necessary signals and analyses the effects thereof. In addition, the measuring arrangement is relatively difficult to parallelise and is often relatively slow.

DE 10 2004 022 752 A1 discloses an apparatus for checking the authenticity of a document of value or a security document, which apparatus operates with a measurement of the dielectric properties.

EP 0 260 221 A2 proposes contactless information transfer for reading a data carrier, a continuously applied alternating voltage of a square-wave generator being used for reading.

The object of the invention is therefore to provide a relatively inexpensive and high-speed reading unit.

According to the invention, that object is achieved by the features of claims 1 and 12.

The system according to the invention for storing and reading information has a data storage medium for storing information and a reading unit for reading the information stored in the data storage medium, the data storage medium having a dielectric and the information being formed by the presence or non-presence of at least one storage electrode in the data storage medium, and the reading unit having at least one input electrode and at least one reading electrode, it being possible for the data storage medium and the reading unit to be coupled to each other, for the purpose of reading the information, in such a manner that the input electrode and the storage electrode form a first capacitor and the reading electrode and the storage electrode form a second capacitor. The reading unit has means for generating a digital voltage jump at the input electrode and means for comparing the voltage jump occurring at the reading electrode with a reference voltage.

In the process according to the invention for reading information from such a data storage medium using such a reading device, a large number of storage electrodes and a large number of input electrodes are present, the input electrodes being acted upon temporally one after the other by a digital voltage jump and the voltage jump occurring at the reading electrode being compared with a reference voltage. Very rapid measurement is thus possible.

The principle according to the invention is based on the use of a digital voltage jump, that is to say, a single pulse, and direct comparison with a reference voltage, as a result of which the signal is immediately present in digital form (1 or 0) and can be further processed inexpensively.

Further forms of the invention are the subject-matter of the subordinate claims.

According to a preferred embodiment, the reading unit also has a microprocessor which, without a great cost factor, can have a large number of digital outputs, so that a large number of storage electrodes can be checked rapidly and reliably.

The means for comparing the voltage jump occurring at the reading electrode with a reference voltage preferably have an operational amplifier in a comparator circuit.

In addition, the storage electrodes of the data storage medium are composed of electrically conductive structures, especially conductive organic polymers, especially PEDOT or PANI, and form a code arrangement. The electrically conductive code arrangement is advantageously produced by a mass printing process, especially by a letterpress, rotogravure or flatbed printing process. Furthermore, the code arrangement can be applied to a flexible substrate, especially paper or film, it being possible for it to be arranged invisibly between two substrates.

Moreover, suitable measures are to be provided for minimising interference. These measures may consist, for example, in the data storage medium having a reference storage electrode which is used to check the reading device. It would also be possible for the storage electrodes to form a redundant code arrangement. Furthermore, in order to filter interference, a low pass and/or a high pass can be arranged upstream of the means for comparing the voltage jump occurring at the reading electrode with a reference voltage.

Further advantages and forms of the invention will be explained in more detail hereinafter by means of the description and the drawings.

In the drawings

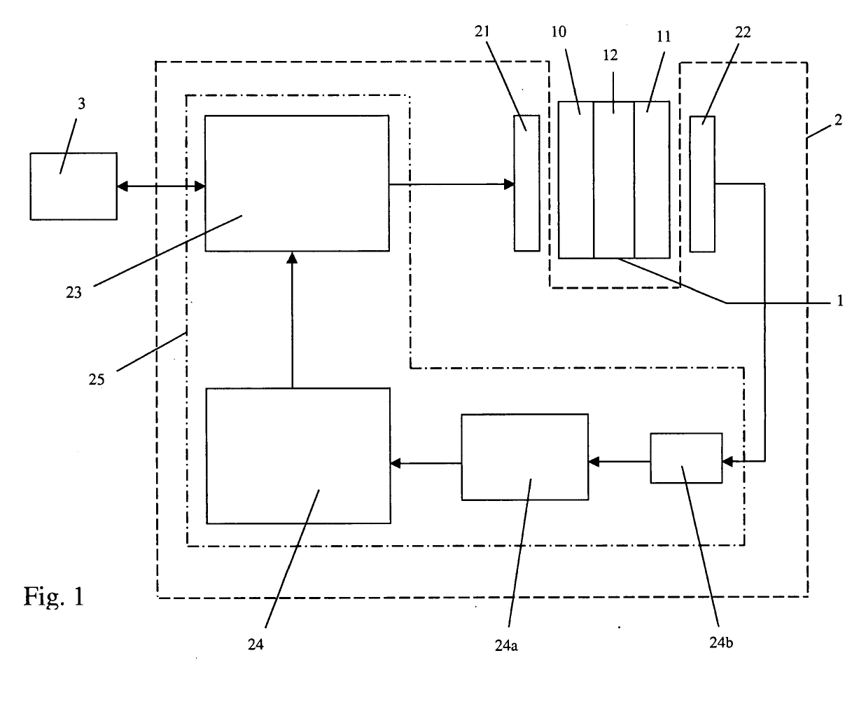

FIG. 1 shows a block diagram of the system for storing and reading information,

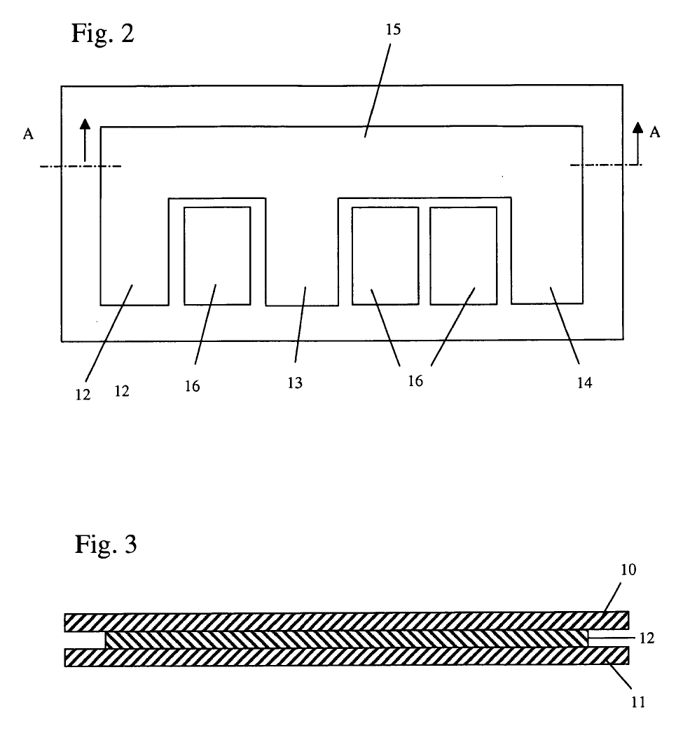

FIG. 2 is a diagrammatic representation of the data storage medium and

FIG. 3 is a sectional representation along the line A-A of FIG. 2.

The system shown in FIG. 1 for storing and reading information has a data storage medium 1 for storing information and a reading unit 2 for reading the information stored in the data storage medium.

The data storage medium shown in more detail in FIG. 2 and FIG. 3 has at least a first dielectric 10 and several storage electrodes 12, 13, 14 and a second dielectric 11, the storage electrodes being arranged between the two dielectrics. In this specific arrangement, the storage electrodes 12, 13, 14 form a code arrangement. The three storage electrodes 12, 13, 14 project in a finger-like manner from a common base surface 15.

The above-described form of the storage electrodes enables them to be embedded between two substrates without any special space requirement.

In the case of the code arrangement shown, up to six storage electrodes are possible. In the embodiment shown, however, only the first, third and sixth fingers are in the form of storage electrodes, while the electrode faces 16 lying therebetween are not connected to the base surface 15. It would of course also be possible for those electrode faces 16 not to be present at all. In the case of a code arrangement having up to six storage electrodes, 2⁶=64 different code arrangements can therefore be produced. Of course, any other desired number of storage electrodes may also be provided. It is especially also possible for all of the storage arrangements to be arranged separately and therefore not to have a common base surface.

Suitable dielectrics 10,11 are especially substrates of paper or film. The code arrangement is advantageously manufactured from conductive organic polymers, especially polythiophene, polyaniline and polypyrrole, PEDOT or PANI, which are printed onto the substrate by means of a mass printing process (letterpress, rotogravure or flatbed printing process). The data storage medium can thus be manufactured in large numbers and in a very rapid and inexpensive manner. If the code statement is additionally embedded between two substrates (dielectric), the code statement is invisible from outside and, as a result, is protected from damage and manipulation. Within the scope of the invention, it is, however, also possible to manufacture the code arrangement from other conductive materials, such as silver particles, carbon particles, ITO nanoparticles.

Furthermore, it would also be possible first of all to print a code arrangement with all possible storage electrodes and to write the actual information into the data storage medium only afterwards, for example by applying to the storage electrodes that are later no longer to be present a correspondingly high voltage pulse which leads to an interruption between the electrode and the base surface.

The reading unit 2 has basically at least one input electrode 21 and at least one reading electrode 22, it being possible to couple the data storage medium 1 and the reading unit 2 to each other, for the purpose of reading the information, in such a manner that the input electrode 21 and the storage electrode 12 form a first capacitor and the reading electrode 22 and the storage electrode 12 form a second capacitor. The reading unit also has means 23 for generating a digital voltage jump at the input electrode 21, and means 24 for comparing the voltage jump occurring at the reading electrode 22 with a reference voltage. The means 24 can have, especially, an operational amplifier 24a in a comparator circuit. Furthermore, the reading unit 2 can comprise a microprocessor 25 which is connected to the means 23 for generating a digital voltage jump at the input electrode 21 and to the means 24 for comparing the voltage jump occurring at the reading electrode 22, or which takes over the tasks thereof completely or partially. The reading unit 2 is also connected to a computer 3 via a USB connection.

In the measuring process, a digital voltage jump, that is to say, a single pulse, is applied to the input electrode 21. Owing to the capacitor characteristics of the arrangement, a voltage jump will then occur at the reading electrode 22. The voltage then decreases exponentially. If, then, a short time after the applied voltage jump the output signal of the reading electrode 22 is evaluated, a conclusion can thereby be drawn as to the presence or non-presence of a storage electrode.

The input electrodes 21 are advantageously provided in relatively large numbers so that one input electrode is associated with each possible storage electrode. If, as in the embodiment shown, all of the storage electrodes are connected to each other by way of a common base surface, only one reading electrode 22 is necessary. The reading electrode is arranged in the region of the base surface 15 while the input electrodes are provided in the finger-like regions. The input electrodes are then acted upon temporally one after the other by a digital voltage jump, so that the respective result can be observed at the reading electrode. It is thus easy to establish which of the possible storage electrodes is actually present or not present.

Owing to the small capacitances to be expected (in the picofarad range), the reading electrode 22 must be connected to a comparator circuit in a very high-resistance manner (several megaohms); as a result, however, all of the interference from the environment (for example 50 Hz humming) is also input to a very great extent. This may possibly lead to not inconsiderable impairment (depending on the form of the printed circuit board and the housing). A few strategies which may contribute individually or together to the minimisation of interference are therefore put forward hereinafter:

When a comparator circuit is used, the comparator output is advantageously checked before the voltage jump. The comparator output must be inactive because otherwise interference is instantaneously present. The measurement is repeated until that interference no longer occurs or until the maximum measurement duration has been reached.

The comparator output is likewise checked after the voltage jump and the measurement of the jump response—after a certain waiting period (in accordance with the period of discharge of the capacitor arrangement). The comparator output must again be inactive, otherwise the measurement is discarded and repeated. This method of measurement reduces measurement errors occurring during interference with a positive level (that is to say, fewer authentic 0 bits than 1 bits are recognised). High-frequency interference is, however, suppressed less well with this method.

Another possibility is for the data storage medium to have one of the electrodes as a reference storage electrode which is used to check the reading device. Immediately before and/or after the measurement of one or all of the storage electrodes, the reference storage electrode is measured. If the reference storage electrode does not give a level, the measurement of the data bits should be discarded. This method reduces measurement errors occurring during interference with a negative level (fewer authentic 1 bits than 0 bits are recognised). High-frequency interference is also difficult to suppress with this method.

Furthermore, it is possible for the means 24 for comparing the voltage jump occurring at the reading electrode 22 with a reference voltage to have a (high-resistance) low pass 24b (RC member) arranged upstream in order to attenuate high-frequency interference. The dimensioning of the low pass should be high enough in the limit frequency to impair only slightly the sharpness of the jump response of the measuring arrangement. An additional high pass would suppress low-frequency interference and would be useful especially for suppressing 50 Hz network frequency interference.

A further very efficient possibility is for the storage electrodes to form a redundant code arrangement so that, after reading the data storage medium, check sums can be formed or integrity tests carried out in order to exclude any interference during the reading of the data bits. Advantageously, not just one but several or even all of the possibilities indicated above are applied for interference minimisation.

1. A system for storing and reading information, having a data storage medium for storing information and a reading unit for reading the information stored in the data storage medium, the data storage medium having a dielectric and the information being formed by the presence or non-presence of at least one storage electrode in the data storage medium, and the reading unit having at least one input electrode and at least one reading electrode, it being possible for the data storage medium and the reading unit to be coupled to each other, for the purpose of reading the information, in such a manner that the input electrode and the storage electrode form a first capacitor and the reading electrode and the storage electrode form a second capacitor, wherein the reading unit has circuit means for generating a digital voltage jump at the input electrode and circuit means for comparing the voltage jump occurring at the reading electrode with a reference voltage.

2. The system according to claim 1, wherein the circuit means for comparing the voltage jump occurring at the reading electrode with a reference voltage have an operational amplifier in a comparator circuit.

3. The system according to claim 1, wherein the reading unit also has a microprocessor which is connected to the circuit means for generating the digital voltage jump at the input electrode and to the circuit means for comparing the voltage jump occurring at the reading electrode with a reference voltage.

4. The system according to claim 1, wherein a large number of storage electrodes and at least a corresponding large number of input electrodes from a large number of first capacitors and the large number of storage electrodes with a reading electrode from the second capacitor.

5. The system according to claim 1, wherein the storage electrodes form a code arrangement which is composed of conductive organic polymers, especially PEDOT or PANI.

6. The system according to claim 1, wherein the storage electrodes form an electrically conductive code arrangement which is produced by a mass printing process, selected from the group consisting of a letterpress, rotogravure or flatbed printing process.

7. The system according to claim 1, wherein the storage electrodes form an electrically conductive code arrangement which is applied to flexible substrates.

8. The system according to claim 1, wherein the storage electrodes form an electrically conductive code arrangement which is arranged in a superficially invisible manner between two substrates.

9. The system according to claim 1, wherein the data storage medium has a reference storage electrode which is used to check the reading unit.

10. The system according to claim 1, wherein the storage electrodes form a redundant code arrangement.

11. The system according to claim 1, wherein the circuit means for comparing the voltage jump occurring at the reading electrode with a reference voltage have at least one of a low pass and a high pass arranged upstream for filtering interference.

12. A process for reading information from a data storage medium with a reading device, wherein a large number of
storage electrodes and a large number of input electrodes are present, comprising generating a digital voltage jump temporally at the input electrodes, and comparing the voltage jump occurring at the reading electrode with a reference voltage.

13. The process according to claim 12, wherein the step of comparing includes the step of checking the voltage jump occurring at the reading electrode with a reference voltage at least once before or after a measurement.

14. The process according to claim 12, further comprising checking at least one reference electrode present in the data storage medium at least once before or after a measurement.

15. The process according to claim 12 further comprising filtering any interference during the reading of the data storage medium.

16. The process according to claim 15, wherein the step of filtering includes forming a redundant code arrangement in the storage electrodes and, after the data storage medium has been read, forming check sums or carrying out integrity tests.
